(19) United States
(12) Patent Application Publication
(10) Pub. No.: US 2006/0010622 A1
(43) Pub. Date: Jan. 19, 2006

(54) Electric toothbrush

(76) Inventors: Haruhiko Naruse, Kadoma-shi (JP); Keizo Ganse, Kadoma-shi (JP); Masanori Kajiwara, Shijonawate (JP)

Correspondence Address: GREENBLUM & BERNSTEIN, P.L.C., 1950 ROLAND CLARKE PLACE, RESTON, VA, 20191, US

(21) Appl. No.: 10/534,713

(22) PCT Filed: Nov. 12, 2003
(86) PCT No.: PCT/JP03/14406

§ 371 Date: May 12, 2005

(30) Foreign Application Priority Data
Nov. 13, 2002 (JP) 2002-330057

(51) Int. Cl. A61C 17/22

(52) U.S. Cl. 15/22.1; 15/28

(57) ABSTRACT

In an electric toothbrush in which a disk-like brush body is reciprocally rotated about an axis intersecting at a predetermined angle in a line extended in a longitudinal direction of a grip portion, a head portion put into user's mouth is made smaller or thinner, a rotation shaft of the brush body and a head portion are enabled incline at an optional angle with respect to the grip portion, and transmission efficiency of driving force is increased. For there purposes, an eccentric member having an eccentric shaft is fixed on a driving shaft of a motor, a joint portion formed at a first end portion of a lever member is made point contact with the eccentric shaft, so that the rotation movement of the eccentric shaft is converted to swing movement of the first end portion of the lever member. In addition, a groove formed at a second-end portion of the lever member and a pin provided on the brush body are engaged with each other, so that swing motion of the second end portion of the lever member is converted to reciprocal rotation motion of the brush body.

### TECHNICAL FIELD

The present invention relates to an electric toothbrush, in particular, a mechanism for reciprocally rotating a disk-like brush body about an axis intersecting at an optional angle including right angle with respect to the longitudinal direction of a grip portion of the electric toothbrush.

### BACKGROUND ART

An electric toothbrush for performing brushing by putting a brush implanted in a brush body on teeth while reciprocally rotating the disk-like brush body about an axis orthogonal to the longitudinal direction of a grip portion of the electric toothbrush has been known conventionally. Such an electric toothbrush requires converting rotating motion of a driving shaft of a motor into reciprocal rotating motion of the brush body as well as converting direction of the rotating shaft into substantially right angle.

In a conventional electric toothbrush described, for example, in Japanese Laid-Open Patent Publication No. 5-137615 (a first conventional example), a motor and a driving mechanism for converting rotating motion of a driving shaft of the motor into reciprocal rotating motion are provided in the grip portion of the electric toothbrush. A coupling shaft is coupled to an output shaft of the driving mechanism through an increasing angle mechanism for increasing rotating angle of reciprocal rotating motion of the output shaft, and a miter gear mechanism is further provided between a front end of the coupling shaft and the disk-like brush body. The brush body is reciprocally rotated about an axis orthogonal to the coupling shaft.

In the first conventional example, since the miter gear mechanism is provided at the front end of the electric toothbrush and the increasing angle mechanism is provided between the output shaft of the driving mechanism and the coupling shaft, there is a certain limit in making a head portion put into a user's mouth smaller or thinner. Furthermore, due to structural restriction of the miter gear mechanism and the increasing angle mechanism, the rotating shaft of the brush body needs to be orthogonal to the output shaft of the driving mechanism, and it is practically impossible to incline the head portion at an optional angle with respect to the grip portion. For this reason, operability during brushing is slightly poor.

In a conventional electric toothbrush described in National Publication of International Patent Application No. 11-505742 (WO96/37164) (a second conventional example), a front end of a coupling shaft coupled to a driving shaft of a motor is bent in a shape of a crank, and the crank-like front end is engaged in a groove of a cylindrical brush body which is supported so as to freely rotate about a rotating shaft orthogonal to the rotating center of the coupling shaft. The crank-like front end rotates like drawing a circle due to rotation of the motor. However, since the crank-like front end slides while rotating in the groove of the brush body, the brush body itself is reciprocally rotated about the rotating shaft within a certain extent.

According to the configuration of the second conventional example, since the groove of the cylindrical brush body must be longer than at least revolving diameter of the crank-like front end of the coupling shaft, the brush body must be upsized. Therefore, as in the case of the first conventional example, there is a certain limit in making the head portion put in the user's mouth smaller or thinner. Further, since the coupling shaft is directly connected to the driving shaft of the motor, it is practically impossible to incline the head portion at an optional angle with respect to the grip portion, so that operability during brushing is slightly poor. Moreover, since the coupling shaft and its bearing must be processed with high accuracy, when accuracy of these portions are poor, transmission efficiency of driving force is lowered or it causes the occurrence of noise.

In a conventional electric toothbrush described in Japanese Laid-Open Patent Publication No. 6-121710 (a third conventional example), a motor and a driving mechanism for converting rotating notion of a driving shaft of the motor into reciprocal linear notion are provided in the grip portion of the electric toothbrush. A coupling shaft, on which a rack is formed at its front end, is connected to the output shaft of the driving mechanism. By engaging the rack at the front end of the coupling shaft which moves reciprocal-linearly with a pinion provided at a rotating shaft of a brush body, the brush body is reciprocally rotated about an axis orthogonal to the coupling shaft.

According to the configuration of the third conventional example, since only the rack and the pinion are provided to rotate the brush body reciprocally at the front end of the head portion, in comparison with the first or second embodiment, it is possible to make the head portion put into the user's mouth smaller or thinner. However, since the coupling shaft is directly connected to the output shaft of the driving mechanism, it is practically impossible to incline the head portion at an optional angle with respect to the grip portion, and operability during brushing is slightly poor. Furthermore, since rotation of the motor is temporarily converted into reciprocal motion of the output shaft and then converted into reciprocal rotating motion of the brush body, transmission efficiency of driving force is slightly low,

### DISCLOSURE OF INVENTION

To solve the above-mentioned conventional problems, an object of the present invention is to provide an electric toothbrush with higher transmittance efficiency of the driving force, which is capable of inclining a rotating shaft of a brush body and a head portion at an optional angle with respect to a grip portion and making the head portion put into a user's mouth smaller or thinner in order to improve operability during brushing.

To achieve the above-mentioned object, an electric toothbrush in accordance with an aspect of the present invention comprises a motor, a brush body pivoted so as to freely swing about a rotating shaft which forms a predetermined angle with a driving shaft of the motor, a lever member which is provided between the motor and the brush body and is pivoted so as to freely swing about a predetermined swinging shaft, a first motion converting mechanism which is provided between the driving shaft of the motor and a first end portion of the lever member positioned at the side of the motor and converts rotating motion of the driving shaft of the motor into swinging motion of the lever member and a second motion converting mechanism which is provided between the brush body and a second end portion of the lever member positioned at the side of the brush body and converts swinging motion of the lever member into reciprocal rotating motion of the brush body.

With such a configuration, since the rotating motion of the driving shaft of the motor is temporarily converted into the swinging motion of the lever member and then the swinging motion of the lever member is converted into the reciprocal rotating motion of the brush body, the brush body can be made thinner in comparison with the first and second conventional examples using the miter mechanism or the crank mechanism. Furthermore, since the lever member which swings about the predetermined swinging shaft is used as a coupling member for transmitting driving force of the motor to the brush body, inner dimension (height of inner space) of the head portion can be reduced to the height obtained by adding a predetermined clearance to the thickness of the lever member. As a result, the head portion put in the user's mouth can be made smaller or thinner.

Furthermore, since the swinging lever member is coupled to the driving shaft of the motor through the first motion converting mechanism, as distinct from the coupling shaft which makes rotating motion, reciprocal linear motion or reciprocal rotating motion in the conventional examples, there is no need to provide the lever member in the same direction as the driving shaft or the output shaft of the driving mechanism. Still furthermore, since the lever member is coupled to the brush body through the second motion converting mechanism, the rotating shaft of the brush body needs not be orthogonal to the swinging plane of the lever member. As a result, it becomes possible to incline the rotating shaft of the brush body and the head portion at an optional angle with respect to the grip portion, thereby improving operability during brushing.

Furthermore, in comparison with the first or third embodiment, since the driving mechanism for temporarily converting rotating motion of the driving shaft of the motor into reciprocal rotating motion or reciprocal linear motion is not required, and rotating motion of the driving shaft of the motor is directly converted into swinging motion of the lever member by the first motion converting mechanism, transmittance efficiency of driving force can be enhanced. Moreover, as in the second conventional example, high accuracy in processing of parts is not required and oscillation or noi se can be reduced.

### BRIEF DESCRIPTION OF DRAWINGS

FIG. 1A is a front sectional view showing a driving mechanism of an electric toothbrush in accordance with a first embodiment of the present invention.

FIG. 1B is a side sectional view showing configuration of a front end of the electric toothbrush in accordance with the first embodiment.

FIG. 2 is a perspective view showing an internal structure of the electric toothbrush in accordance with the first embodiment from which a housing is removed.

FIG. 3 is an exploded perspective view showing a configuration of a first motion converting mechanism in the first embodiment.

FIG. 4 is a perspective view showing a shape in the vicinity of a second end portion of a lever member.

FIG. 5 is a perspective view showing a configuration of a brush body in the first embodiment.

FIG. 6A, FIG. 6B and FIG. 6C are views respectively showing a configuration and a motion converting operation of a second motion converting mechanism in the first embodiment.

FIG. 7A and FIG. 7B are partial sectional views showing a configuration of a modification example of the first motion converting mechanism in the first embodiment.

FIG. 8A, FIG. 8B and FIG. 8C are front views respectively showing a configuration and an operation of another modification example of the second motion converting mechanism in the first embodiment.

FIG. 9 is a side view showing an appearance of an electric toothbrush in accordance with a second embodiment of the present invention.

FIG. 10 is a perspective view showing an internal structure of the electric toothbrush in accordance with the second embodiment from which a housing is removed.

FIG. 11 is a perspective view showing a shape of a lever member of a modification example in accordance with the second embodiment.

FIG. 12 is a perspective view showing an internal structure of the electric toothbrush of another modification example in accordance with the second embodiment from which a housing is removed.

FIG. 13 is a front sectional view showing a configuration of the electric toothbrush of still another modification example in accordance with the second embodiment.

FIG. 14 is a side sectional view showing a configuration of a front end of an electric toothbrush in accordance with a third embodiment of the present invention.

FIG. 15 is a view showing relationship between rotation angle of the brush body and pressure of a brush, a thin line A shows characteristics of a conventional electric toothbrush and a thick line B shows characteristics of the electric toothbrush in accordance with the third embodiment.

FIG. 16A and FIG. 16B are side views showing an outer structure of an electric-toothbrush in accordance with a fourth embodiment of the present invention.

FIG. 17A and FIG. 17B are a front sectional view and its partial enlarged sectional view showing a driving mechanism of an electric toothbrush in accordance with a fifth embodiment of the present invention, respectively.

FIG. 18A to FIG. 18D are views respectively showing an operation of a first motion converting mechanism in accordance with the fifth embodiment.

### BEST MODE FOR CARRYING OUT THE INVENTION

### First Embodiment

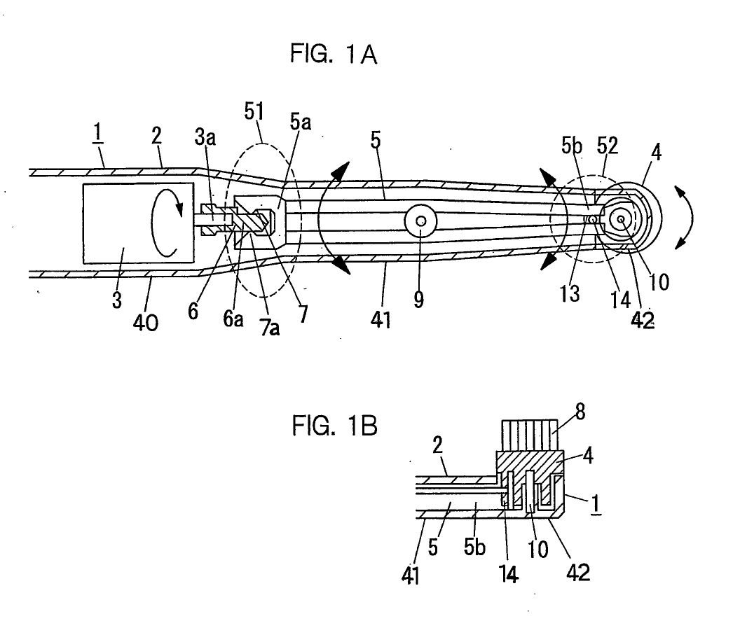

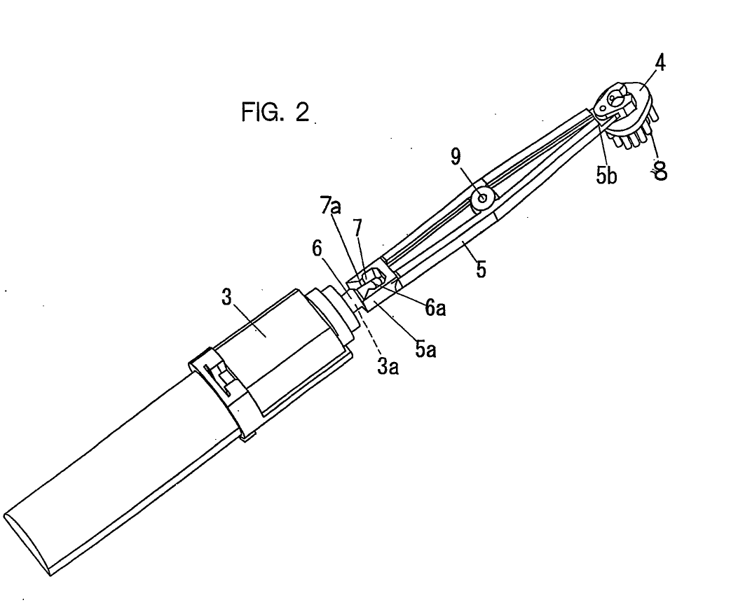

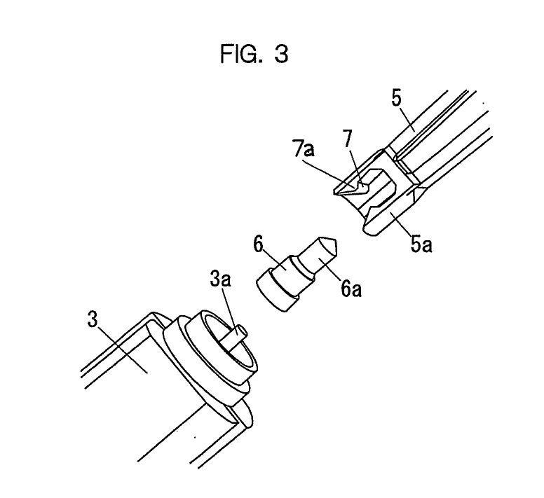

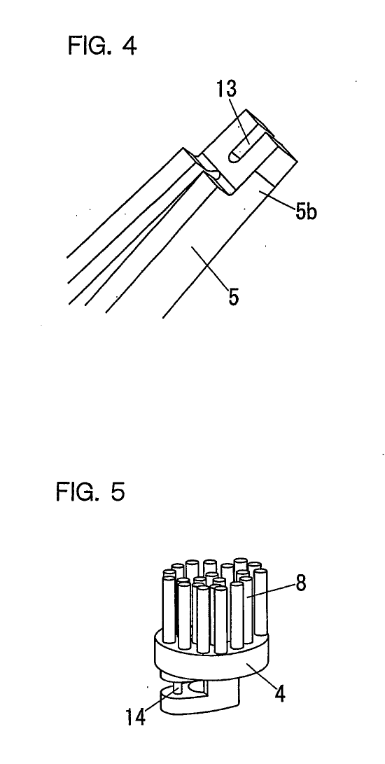

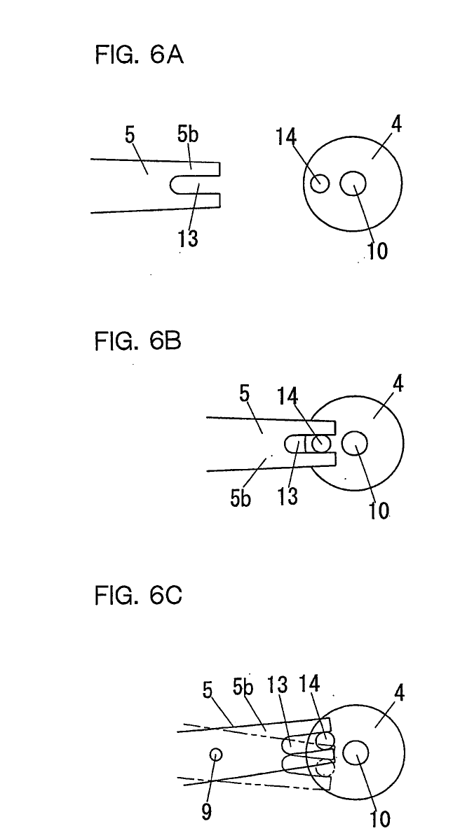

A first embodiment of the present invention will be described with reference to figures. FIG. 1A is a front sectional view showing a driving mechanism of an electric toothbrush in accordance with the first embodiment and FIG. 1B is a side sectional view of its front end. FIG. 2 is a perspective view showing an internal structure of the electric toothbrush from which a housing is removed. FIG. 3 is an exploded perspective view showing a configuration of a first motion converting mechanism. FIG. 4 is a perspective view showing a shape in the vicinity of a second end portion of a lever member. FIG. 5 is a perspective view showing a configuration of a brush body. FIG. 6A, FIG. 6B and FIG. 6C are views showing a configuration and a motion converting operation of a second motion converting mechanism.

As shown in FIG. 1A and FIG. 2, an electric toothbrush 1 in accordance with the first embodiment comprises a motor 3 as a driving source, and a driving force transmitting mechanism for transmitting driving force to a brush body 4 in a housing 2. The brush body 4 is formed like a disk and detachably attached to a main body (a grip portion 40 and a head portion 41) of the electric toothbrush 1 together with a front end 42. In the first embodiment, the grip portion 40 and the head portion 41 among the housing 2 are formed integrally. The head portion 41 is not inclined with respect to the longitudinal direction of the grip portion 40.

As shown in FIG. 1B and FIG. 5, a brush 8 is implanted in an outer face of the brush body 4. A rotating shaft 10 and a pin 14 engaged with a lever member 5 described later are provided on an inner face of the brush body 4. In the first embodiment, the rotating shaft 10 of the brush body 4 is formed in a direction substantially orthogonal to a swinging plane of the lever member 5 which couples a driving shaft 3a of the motor 3 to the brush body 4. In addition, the swinging plane of the lever member 5 is parallel to the driving shaft 3a of the motor 3.

The driving force transmitting mechanism is comprised of the lever member 5 pivoted by the head portion 41 so as to freely swing about an swinging shaft 9, a first motion converting mechanism 51 for converting rotation of the driving shaft 3a of the motor 3 into swinging of the lever member 5, and a second motion converting mechanism 52 for converting swinging of the lever member 5 into reciprocal rotating motion of the brush body 4. In addition, the lever member 5 serves as a coupling member for coupling the driving shaft 3a of the motor 3 to the brush body 4.

The first motion converting mechanism 51 is comprised of an eccentric member 6 press-fitted to the driving shaft 3a of the motor 3, and a joint portion 7 which is formed at a first end portion 5a of the lever member 5 positioned at the side of the motor 3 and engaged with an eccentric shaft 6a of the eccentric member 6. The second motion converting mechanism 52 is comprised of a groove 13 formed at a second end portion Sb of the lever member 5 positioned at the side of the brush body 4 and the pin 14 of the brush body 4 engaged with the groove 13.

The eccentric member 6 and the lever member 5 are formed of a material which has a small friction coefficient and is excellent in abrasion resistance, for example, polyacetal resin. The eccentric shaft 6a of the eccentric member 6 is formed so as to be located at a predetermined distance from the center of the driving shaft 3a in the state where the eccentric member 6 is press-fitted to the driving shaft 3a of the motor 3. Accordingly, when the driving shaft 3a of the motor 3 rotates, the eccentric shaft 6a of the eccentric member 6 rotates about the driving shaft 3a with a radius of the predetermined distance. Meanwhile, a pair of protrusions 7a each having a substantially triangular cross section are formed at the joint portion 7 of the lever member 5 so as to be brought into point-contact with a cylindrical face of the eccentric shaft 6a of the eccentric member 6 from both sides.

As described above, since the lever member 5 is pivoted so as to freely swing about the swinging shaft 9, when the eccentric shaft 6a of the eccentric member 6 rotates, the eccentric shaft 6a rotates while sliding between a pair of the protrusions 7a. With rotating motion, since the center of the eccentric shaft 6a reciprocates in a direction parallel to the paper sheet of FIG. 1A, for example, the lever member 5 swings about the swinging shaft 9 as a center while changing contact position between the eccentric shaft 6a and the protrusions 7a. Meanwhile, as shown in FIG. 6B, the pin 14 of the brush body 4 is slidably engaged in the groove 13 formed at the second end portion 5b of the lever member 5. Thus, as shown in FIG. 6C, the brush body 4 is reciprocally rotated at a constant angle with swinging of the second end portion 5b of the lever member 5.

As described above, according to the first embodiment, although rotation of the driving shaft 3a of the motor 3 is temporarily converted into swinging of the lever member 5 and then the swinging of the lever member 5 is converted into reciprocal rotation of the brush body 4, friction area contributing to a decrease in transmission efficiency of driving force is smaller, and therefore, driving force of the motor 3 can be transmitted to the brush body 4 efficiently. Further, since the pin 14 formed at the inner face of the brush body 4 is only engaged in the groove 13 of the lever member 5, as shown in FIG. 1B, an amount of protrusion from the inner face of the brush body 4 can be reduced to the height of the pin 14, that is, the height obtained by adding a predetermined clearance to the thickness of the lever member 5. Similarly, the inner height (thickness) of the head portion 41 among the housing 2, in which the lever member 5 is provided, can be also reduced to the height obtained by adding a predetermined clearance to the thickness of the lever member 5. As a result, the head portion 41 including the front end 42 that is put into a user's mouth can be made smaller or thinner.

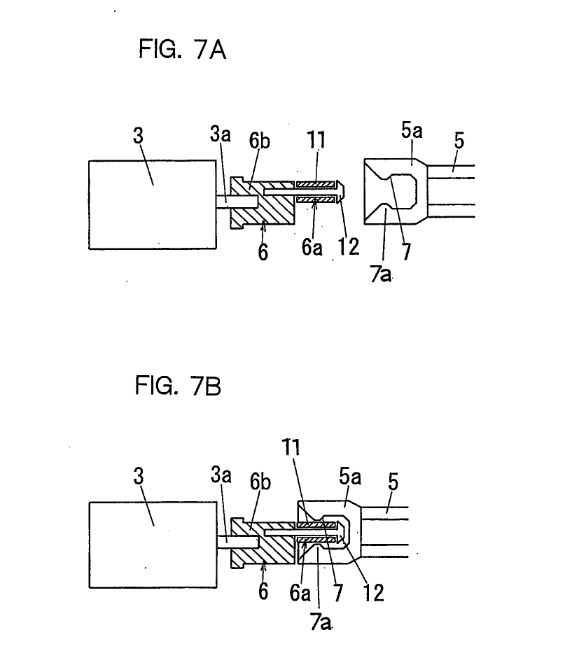

Subsequently, an example of modification of the first embodiment is shown in FIG. 7A and FIG. 7B. In this modification example, the eccentric shaft 6a of the eccentric member 6 is comprised of a roller 11 and a shaft 12. Specifically, the eccentric member 6 is comprised of a base portion 6b press-fitted to the driving shaft 3a of the motor 3, the shaft 12 press-fitted to a hole formed on the base portion 6b and the roller 11 rotatably pivoted by the shaft 12. A flange is formed at the opposite side to the side where the shaft 12 is press-fitted so that the roller 11 does not remove therefrom. With such a configuration, although sliding friction occurs between the roller 11 and the shaft 12, friction between the roller 11 and the protrusion 7a of the joint portion 7 of the lever member 5 is decreased greatly. Accordingly, although the number of parts is increased, relatively low-priced general resin material can be adopted as materials for the base portion 6b and the roller 11 constituting the eccentric member 6 and the lever member 5 without need for using expensive material having small friction coefficient and excellent abrasion resistance. In addition, since sliding friction between the roller 11 and the shaft 12 is generated in line contact, wear becomes relatively small.

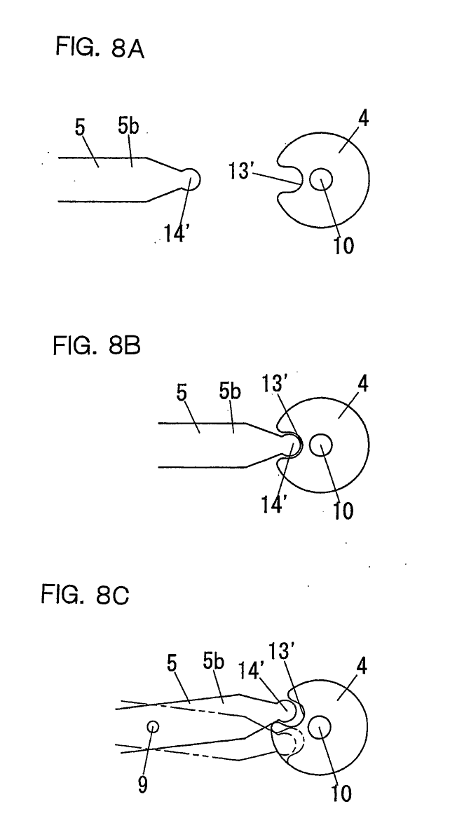

Furthermore, another example of modification of the first embodiment is shown in FIG. 8A, FIG. 8B and FIG. 8C. In this modification example, a substantially circular protrusion 14′ (corresponding to the pin 14) is formed at the second end portion 5b of the lever member 5 as the second motion converting mechanism 52 and a substantially U-shaped groove 13′ to which the protrusion 14′ is engaged is formed at the brush body 4. The similar effects to the above-mentioned ones can be achieved by such configuration.

### Second Embodiment

A second embodiment of the present invention will be described with reference to figures. In the second embodiment, the rotating shaft 10 of the brush body 4 and a central axis of the head portion 41 are inclined by inclining the swinging plane of the second end portion 5b of the lever member 5 at a predetermined angle not parallel to the driving shaft 3a of the motor 3.

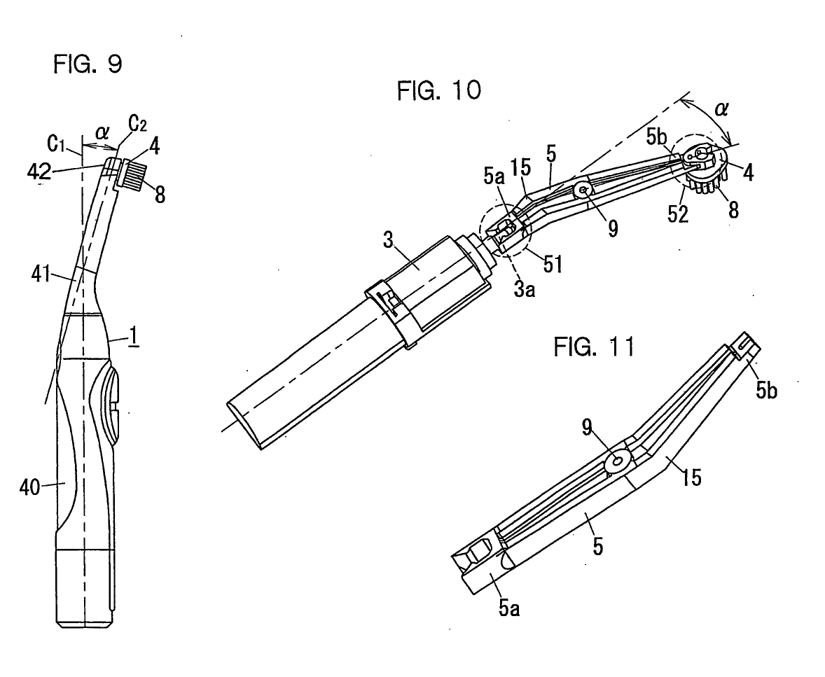

FIG. 9 is a side view showing an appearance of an electric toothbrush 1 in accordance with the second embodiment, FIG. 10 is a perspective view showing an internal structure of the electric toothbrush 1 from which a housing is removed, and FIG. 11 is a perspective view showing a shape of the lever member 5 in a modification example.

As can be seen from FIG. 9, in the second embodiment, the lever member 5 for coupling a driving shaft 3a of a motor 3 to a brush body 4 and a head portion 41 at which the lever member 5 is provided (the axis is referred to as C₂) are inclined to any angle α (for example, about 10 degrees) with respect to the longitudinal direction of a main body of the electric toothbrush 1 (a grip portion 40) (the axis is referred to as C₁). Thus, as shown in FIG. 10 and FIG. 11, the cross section of the lever member 5 orthogonal to the rotating plane is formed substantially in the dog-legged shape. An inflected portion 15 of the lever member 5 may be provided between a first end portion 5a and a swinging shaft 9 as shown in FIG. 10 or between a second end portion 5b and the swinging shaft 9 as shown in FIG. 11. In the former case, the swinging shaft 9 of the lever member 5 is, for example, provided so as to form a predetermined angle other than right angle with the driving shaft 3a of the motor 3.

Since rotating motion of the driving shaft 3a of the motor 3 is temporarily converted into swinging motion and then the swinging motion is converted into reciprocal rotating motion of the brush body 4 by using the swinging lever member 5 in this manner, even when the plane orthogonal to the rotating plane of the lever member 5 is inflected substantially in the dig-legged shape, driving force of the motor 3 can be transmitted to the brush body 4 reliably.

Furthermore, by inclining the central axis C2 of the head portion 41 having the brush body 4 at the predetermined angle α with respect to the central axis C1 of the grip portion 40 held by the user for hand motion, the front end of the brush 8 can easily be put to every corner of teeth, thereby enabling improvement in operability and removal of plaque with high efficiency.

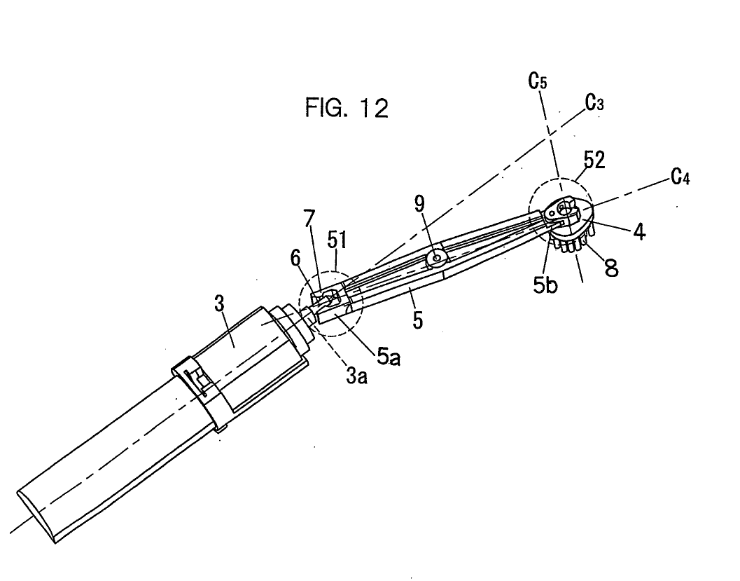

Another example of modification of the second embodiment is shown in FIG. 12. In this modification example, as in the first embodiment, the lever member 5 includes no inflected portion 15 and has the substantially rectangular cross section orthogonal to the rotating plane.

As described above, a first motion converting mechanism 51 is comprised of an eccentric member 6 and a joint portion 7 engaged with an eccentric shaft 6a of the eccentric member 6, and the eccentric shaft 6a and the protrusion 7a of the joint portion 7 are brought into point-contact with each other. Thus, the direction of the joint portion 7 with respect to the eccentric shaft 6a is not limited specifically. As shown in FIG. 12, there occurs no problem even when a main axis C₄ orthogonal to the rotating axis of the lever member 5 is inclined with respect to a central axis C₃ of the driving shaft 3a of the motor 3.

A second motion converting mechanism 52 is comprised of a groove 13 formed at a second end portion 5b of the lever member 5 and a pin 14 of the brush body 4 engaged in the groove 13, and side walls of the groove 13 and the pin 14 are brought into line-contact with each other. Thus, as far as the groove 13 and the pin 14 are engaged with each other, an axial direction of the pin 14, that is, an axis C₅ of the brush body 4 need not intersect at right angles and can be inclined at any angle with respect to the main axis C₄ orthogonal to the swinging shaft 9 of the lever member 5. In other words, the pin 14 can form an optional angle including right angle with the longitudinal direction of the groove 13.

Taking from these matters, the rotating shaft 10 of the brush body 4 can form an predetermined angle other than right angle with the rotating plane of the second end portion of the lever member 5. That is, the angle of the brush 8 with respect to the grip portion 40 can optionally be set within a certain extent and operability can be further improved. With such a configuration, it is needless to say that driving force of the motor 3 can be transmitted to the brush body 4 certainly.

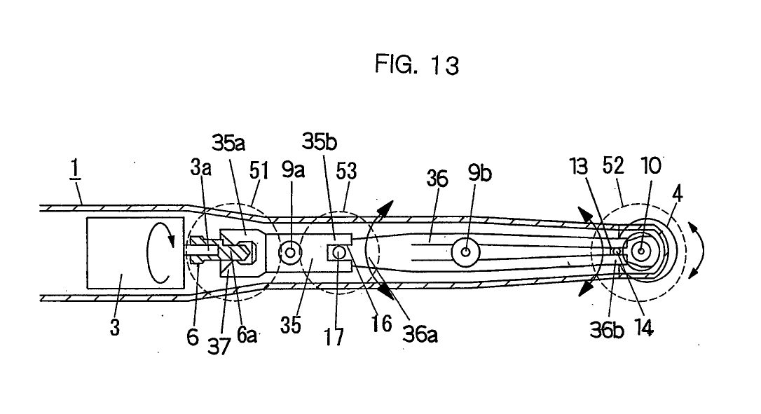

Still another example of modification of the second embodiment is shown in FIG. 13. In this modification example, driving force of the motor 3 is transmitted to the brush body 4 by using a swinging first lever member 35 and a second lever member 36 instead of the single lever member 5.

The first lever member 35 is pivoted so as to swing about a swinging shaft 9a, formed at a first end portion 35a at the side of the motor 3 and has a joint portion 37 engaged with the eccentric shaft 6a of the eccentric member 6 and a groove 16 formed at a second end portion 35b at the side of the second lever member 36.

The second lever member 36 is pivoted so as to swing about a swinging shaft 9b, formed at a first end portion 36a at the side of the first lever member 35 and has a pin 17 engaged in the groove 16 and the groove 13 formed at the second end portion 36b of the second lever member 36.

The first motion converting mechanism 51 is comprised of the eccentric member 6 and the joint portion 37 of the first lever member 35. The second motion converting mechanism 52 is comprised of the groove 13 formed at a second end portion 36b of the second lever member 36 and the pin 14 of the brush body 4. A third motion converting mechanism 53 is comprised of the groove 16 formed at the first end portion 35a of the first lever member 35 and the pin 17 of the second lever member 36.

With such a configuration, in spite of an increase in the number of parts, flexibility of design is improved. For example, the main axis orthogonal to the swinging shaft 9a of the first lever member 35 may be inclined with respect to the driving shaft 3a of the motor 3 and the main axis orthogonal to the swinging shaft 9b of the second lever member 36 may be inclined with respect to the main axis of the first lever member 35. By inclining the axis in two steps, the inclination angle of the housing 2 in the vicinity of the brush body 4 can be increased. Alternatively, only the main axis of the second lever member 36 may be inclined with respect to the main axis of the first lever member 35 without inclining the main axis of the first lever member 35 with respect to the center of the driving shaft 3a of the motor 3. Further, although not shown, three or more lever members may be provided.

As described above, according to the second embodiment, since the swinging plane of the second end portion 5b of the lever member 5 is inclined at an optional angle with respect to the longitudinal direction of the driving shaft 3a of the motor 3 or the grip portion 40, the head portion 41 including the front end 42 can be inclined with respect to the grip portion 40. Moreover, since the rotating shaft 10 of the brush body 4 can be also inclined at any angle including right angle with respect to the rotating plane of the lever member 5, it is possible to improve to operability during brushing and remove plaque efficiently.

### Third Embodiment

A third embodiment of the present invention will be described with reference to figures. In the third embodiment, to achieve more efficient brushing, a rotating shaft 10 of a brush body 4 is supported swingably. Other configuration except for a front end 42 of an electric toothbrush may be either one described in the first embodiment or the second embodiment.

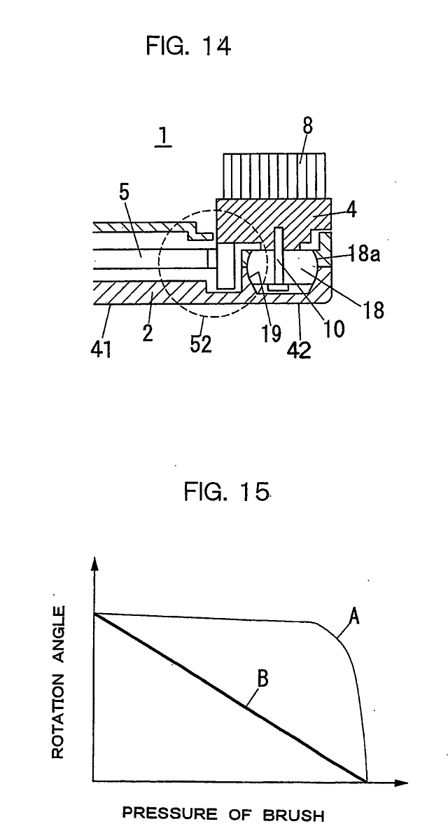

As shown in FIG. 14, the rotating shaft 10 of the brush body 4 is rotatably pivoted by a holding member 18 having a spherical side face 18a. and the holding member 18 is engaged with a cotyloid portion 19 formed at the inner side of the front end 2c of the housing 2 so as to freely rotate in the three-dimensional direction to form a spheroid joint. With such a configuration, the brush body 4 which rotates about the rotating shaft 10 can freely change orientation in the three-dimensional direction, integrally with the holding member 18 holding the rotating shaft 10. Thus, the brush body 4 is inclined freely depending on the angle at which the brush 8 comes into contact with teeth during use and the tooth surface matches with the brush surface. As a result, smooth and efficient brushing can be achieved. Even when the brush body 4 is inclined in any direction, driving force is surely transmitted to the brush body 4 through the second motion converting mechanism 52.

To improve safety of brushing, it is possible to make rotation angle of the brush body 4 smaller when the brush 8 is pressed strongly. Specifically, bending rigidity of the lever member 5 is set so that swinging range of the second end portion 5b located at the side of the brush body 4 of the lever member 5 becomes smaller as a load transmitted from the brush body 4 to the lever member 5 through the second motion converting mechanism 52 is increased. The bending rigidity of the lever member 5 can be set by properly selecting strength of the used material and geometrical moment of inertia.

The relationship between rotation angle of the brush body 4 and pressure of the brush 8 is shown in FIG. 15. In FIG. 15, a thin line A represents characteristics of a conventional electric toothbrush and a thick line B represents characteristics of the electric toothbrush in accordance with the third embodiment. In the conventional electric toothbrush, as represented by the thin line A, when pressure is increased, the number of revolutions is reduced, but rotation angle is kept substantially constant. Thus, there is the possibility that moving distance of the brush 8 stays unchanged, thereby causing damage to the gums and enamelum of the tooth surface. On the contrary, in the case where bending rigidity of the lever member 5 is set as described above, as represented by the thick line B, rotation angle is decreased as pressure is increased and moving distance of the brush 8 is decreased gradually. As a result, damage to the gums and enamelum of the tooth surface can be prevented, leading to a riskless electric toothbrush.

### Fourth Embodiment

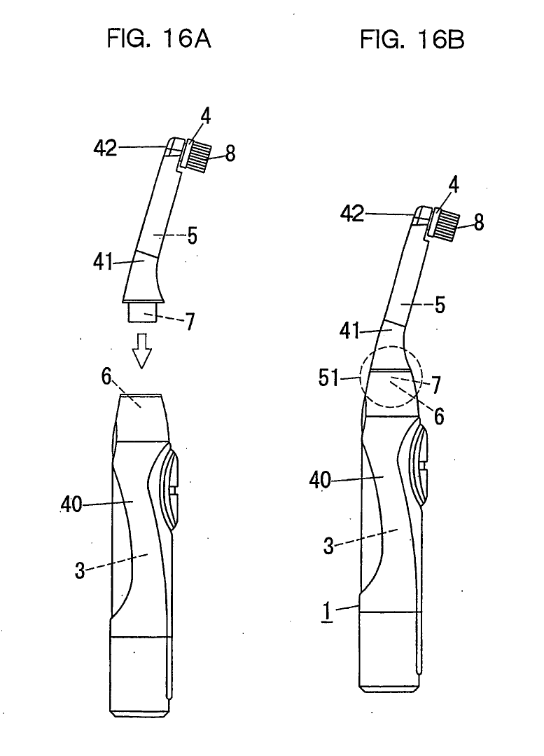

A fourth embodiment of the present invention will be described with reference to figures. In the fourth embodiment, a head portion 41 is configured so as to be detachable from a grip portion 40. FIG. 16A shows the state where the head portion 41 is detached from the grip portion 40 and FIG. 16B shows the state where the head portion 41 is attached to the grip portion 40. An internal configuration of an electric toothbrush 1 may be either one described in the first embodiment or the second embodiment.

As described above, by providing a motor 3 and an eccentric member 6 at the side of the grip portion 40 and making a brush body 4 and a lever member 5 detachable along with the head portion 41, when the head portion 41 becomes dirty, for example, the part of the electric toothbrush 1 which is put into a user's mouth can be replaced, thereby maintaining proper sanitation.

### Fifth Embodiment

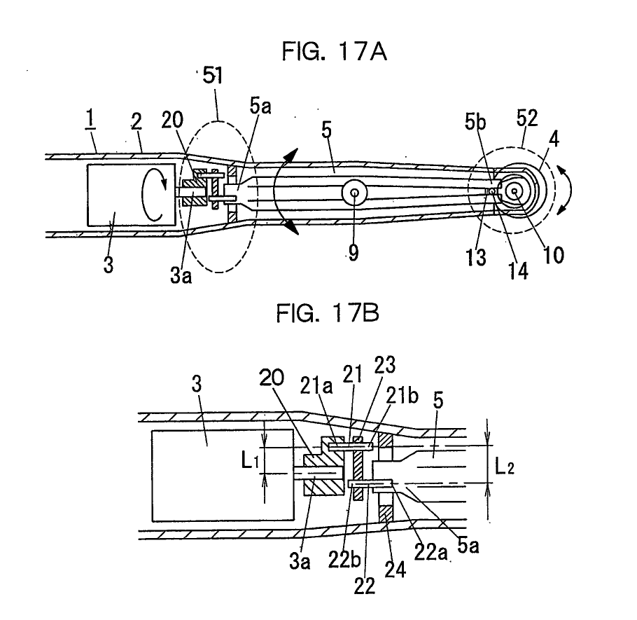

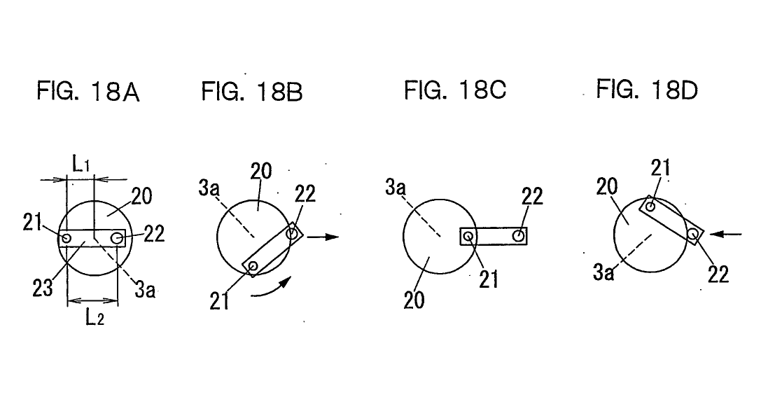

An electric toothbrush in accordance with a fifth embodiment of the present invention will be described with reference to figures. FIG. 17A is a front sectional view showing a driving mechanism of an electric toothbrush 1 in accordance with the fifth embodiment and FIG. 17B is an enlarged view of vicinity of a first motion converting mechanism 51. FIGS. 18A to 18D are views showing operation of the first motion converting mechanism 51 in the fifth embodiment. Since the fifth embodiment is different from the first or second embodiment only in configuration of the first motion converting mechanism 51, other components are designated by the same reference numerals and description thereof is omitted.

As shown in FIG. 17A and FIG. 17B, a driving shaft 3a of a motor 3 is press-fitted to a link member 20. A first end portion 2a of a first link shaft 21 is press-fitted at the position with a predetermined distance L1 from the driving shaft 3a of the link member 20 in the radial direction. The first link shaft 21 is parallel to the driving shaft 3a of the motor 3 and a second end portion 21b of the first link shaft 21 is protruded toward the side of a lever member 5. A first end portion 22a of a second link shaft 22 is press-fitted to a first end portion 5a of the lever member 5 in parallel with the main axis of the lever member 5. A second end portion 22b of the second link shaft 22 is protruded toward the side of the motor 3. The second end portion 21b of the first link shaft 21 and the second end portion 22b of the second link shaft 22 are coupled with each other via a link arm 23 at a distance L2 in the radial direction of the link member 20. At this time, the position of a fitting hole of a link arm 23 is set so that the distance between the first link shaft 21 and the second link shaft 22 is longer than the distance L1 between the driving shaft 3a of the motor 3 and the first link shaft 21 (L1<L2). A lever member support plate 24 for restricting the direction of notion of the first end portion 5a to a predetermined linear direction is provided on the periphery of the first end portion 5a of the lever member 5.

With such a configuration, as shown in FIGS. 18A to 18D, when the link member 20 rotates integrally with the driving shaft 3a of the motor 3, the first link shaft 21 performs rotating motion with a radius of L1. In response to the rotating motion, the second link shaft 22 moves while keeping the distance L2 from the first link shaft 21 via the link arm 23. However, since motion of the lever member 5 is restricted by the lever member support plate 24, the second link shaft 22 makes reciprocal linear motion in the predetermined direction in response to rotating motion of the first link shaft 21. As a result, the first end portion 5a of the lever member 5 swings about a swinging shaft 9.

As described above, since the first link shaft 21 functions as a crank and the second link shaft 22 functions as a slider, a slider-crank mechanism for converting rotating motion of the driving shaft 3a of the motor 3 into reciprocal linear motion is constituted.

This application is based on Japanese Patent Publication No. 2002-330057 and the contents should be incorporated into the present application by referring to specification and figures of the patent application.

While the present invention has been fully described in its embodiments with reference to the appended figures, it will be obvious to those skilled in the art that various changes and variations may be made. Therefore, it is to be understood that the changes and variations falls within the scope of the present invention without departing from the scope of the present invention.

### INDUSTRIAL APPLICABILITY

As described above, according to the present invention, the electric toothbrush, in particular, the disk-like brush body of the electric toothbrush is reciprocally rotated about an axis intersecting at a predetermined angle with respect to the longitudinal direction of the grip portion of the electric toothbrush. A head portion which is put in a user's mouth is made smaller and thinner, a rotating shaft of the brush body and the head portion are inclined at any angle with respect to the grip portion, and operability during brushing can be improved. Furthermore, transmission efficiency of driving force can be enhanced.

1. An electric toothbrush comprising:
a motor;
a brush body pivoted so as to freely rotate about a rotating shaft which forms a predetermined angle with a driving shaft of the motor;
a lever member which is provided between the motor and the brush body and is pivoted so as to swing about a predetermined swinging shaft;
a first motion converting mechanism which is provided between the driving shaft of the motor and a first end portion of the lever member positioned at the side of the motor and converts rotating motion of the driving shaft of the motor into swinging motion of the lever member; and
a second motion converting mechanism which is provided between the brush body and a second end portion of the lever member positioned at the side of the brush body and converts swinging motion of the lever member into reciprocal rotating motion of the brush body.

2. The electric toothbrush as stated in claim 1, wherein
the first motion converting mechanism is comprised of an eccentric member which is coupled to the driving shaft of the motor, has an eccentric shaft and rotates about the driving shaft corresponding to rotating motion of the driving shaft, and a joint portion which is provided at the first end portion of the lever member, comes into contact with an outer peripheral face of the eccentric shaft of the eccentric member, and converts rotating motion of the eccentric shaft into swinging motion of the lever member, and the swinging shaft may form an optional angle including right angle with respect to the driving shaft of the motor.

3. The electric toothbrush as stated in claim 2, wherein the eccentric shaft of the eccentric member is comprised of a roller which rotates about an axis in parallel with the driving shaft of the motor.

4. The electric toothbrush as stated in claim 1, wherein the first motion converting mechanism is a slider-crank mechanism for converting rotating motion of the driving shaft of the motor into reciprocal linear motion of the first end portion of the lever member.

5. The electric toothbrush as stated in claim 1, wherein the second motion converting mechanism is comprised of a pin provided at one of the second end portion of the lever member or the brush body and a groove which is provided at the other of the second end portion of the lever member or the brush body and with which the pin is slidably engaged, and an axis of the pin may form an optional angle including right angle with respect to the longitudinal direction of the groove.

6. The electric toothbrush as stated in claim 1, wherein a swinging plane of the second end portion of the lever member is not parallel with the driving shaft of the motor and forms a predetermined angle with respect to the driving shaft of the motor.

7. The electric toothbrush as stated in claim 6, wherein the rotating shaft of the brush body forms a predetermined angle except substantially right angle with respect to the swinging plane of the second end portion of the lever member.

8. The electric toothbrush as stated in claim 6, wherein the lever member is provided with an inflected portion between the swinging shaft and the first end portion or the second end portion, and a cross section orthogonal to the swinging plane is formed substantially in a dog-legged shape.

9. The electric toothbrush as stated in claim 6, wherein the swinging shaft of the lever member forms a predetermined angle except substantially right angle with respect to the driving shaft of the motor.

10. The electric toothbrush as stated in claim 1, wherein bending rigidity of the lever member is set so that swinging range of the second end portion of the lever member becomes smaller as a load transmitted from the brush body to the lever member through the second motion converting mechanism is increased.

11. The electric toothbrush as stated in claim 1, wherein the rotating shaft of the brush body is supported by a holding member held so as to freely rotate in the three-dimensional direction.

12. The electric toothbrush as stated in claim 11, wherein a head portion provided with the lever member and the brush body is formed so as to detachable from a grip portion provided with the motor.

13. An electric toothbrush comprising:
a motor;
a brush body pivoted so as to freely rotate about a rotating shaft which forms a predetermined angle with a driving shaft of the motor;
a plurality of lever members which is provided between the motor and the brush body, each pivoted so as to swing about a predetermined swinging shaft and coupled with each other so as to freely swing in the reverse direction to each other;
a first motion converting mechanism which is provided between the driving shaft of the motor and a first end portion of the lever member closest to the motor among the lever members and converts rotating motion of the driving shaft of the motor into swinging motion of the lever member; and
a second motion converting mechanism which is provided between the brush body and a second end portion of the lever member closest to the brush body among the lever members and converts swinging motion of the lever member into reciprocal rotating motion of the brush body.

14. The electric-toothbrush as stated in claim 13, wherein a rotating plane of any lever member among a plurality of the lever members is inclined with respect to a rotating plane of other lever member.
